(19) United States
(12) Patent Application Publication
(10) Pub. No.: US 2025/0178288 A1
(43) Pub. Date: Jun. 5, 2025

(54) DEVICE FOR AN ULTRASONIC WELDING OF A WORKPIECE, AND METHOD FOR OPERATING SUCH A DEVICE

(71) Applicant: HERRMANN ULTRASCHALLTECHNIK GMBH & CO. KG, Karlsbad (DE)

(72) Inventor: Volker AUST, Birkenfeld (DE)

(21) Appl. No.: 18/843,525

(22) PCT Filed: Mar. 23, 2023
(86) PCT No.: PCT/EP2023/057469

§ 371 Date: Sep. 3, 2024

(30) Foreign Application Priority Data
Apr. 7, 2022 (DE) 10 2022 108 397.7

(51) Int. Cl. B29C 65/78; B29C 65/08

(52) U.S. Cl. CPC B29C 65/7864; B29C 65/08; B29C 65/7802

(57) ABSTRACT

An apparatus for ultrasonic welding of a workpiece with a machine stand, a welding unit having a sonotrode, and a setting slide connected to the machine stand, which carries the welding unit and is movable in an infeed direction (Z) relative to the machine stand between a rear position and a front position, wherein a processing slide connected to the welding unit and the setting slide is provided, which can be moved together with the welding unit in the infeed direction (Z) relative to the setting slide between a start position and an end position, wherein a processing slide drive is provided, with which the processing slide can be moved in the infeed direction (Z) relative to the setting slide In order to improve the cycle time and the welding accuracy a setting slide drive is provided, with which the setting slide can be moved in the infeed direction (Z) relative to the machine stand.

### FIELD OF THE INVENTION

The present invention relates to an apparatus for ultrasonic welding of a workpiece. Such an apparatus comprises a machine stand, a welding unit with a sonotrode and a setting slide connected to the machine stand, which carries the welding unit and is movable in an infeed direction (Z) relative to the machine stand between a rear position and a front position, wherein a processing slide connected to the welding unit and the setting slide is provided, which can be moved together with the welding unit in the infeed direction (Z) relative to the setting slide between a start position and an end position, wherein a processing slide drive is provided, with which the processing slide can be moved in the infeed direction relative to the setting slide,

### BACKGROUND OF THE INVENTION

An apparatus for ultrasonic welding is known from EP 2 105 280 A2.

In addition to the sonotrode, welding units have a converter and, if necessary, an amplitude transformer. The converter is connected to the sonotrode either directly or, if an amplitude transformer is present, via this.

The converter converts an electrical alternating voltage into a mechanical oscillation. The individual elements of the welding unit are tuned to each other in such a way that the welding unit has a resonant frequency, the so-called natural frequency, at the desired ultrasonic frequency. If the converter is therefore supplied with the appropriate alternating voltage, the welding unit oscillates at the natural frequency.

Furthermore, an anvil arranged opposite the sonotrode can be provided. To process a workpiece, the workpiece is positioned in a gap between the sonotrode and the anvil. During processing, the sonotrode, which vibrates at an ultrasonic frequency, is pressed onto the workpiece in the direction of the anvil so that the workpiece is ultrasonically welded between the sonotrode on the one hand and the anvil on the other.

For this purpose, it is necessary that the sonotrode and anvil can be moved relative to each other. For example, the gap between the sonotrode and anvil must be enlarged in order to be able to insert the workpiece into the gap. The gap is then reduced accordingly during processing. The welding unit is therefore attached to a setting slide, which can be moved relative to the anvil so that the welding unit can be moved together with the setting slide in the direction of force, i.e. towards or away from the anvil.

Often no anvil is used. The workpiece to be processed can be arranged in a receptacle, whereby the sonotrode is pressed onto a certain area of the workpiece. To remove the welded workpiece from the receptacle, it is also necessary to move the sonotrode away from the workpiece. For the next welding process, the sonotrode must then be moved in the opposite direction again.

In order to achieve an optimum processing result, it is advantageous if the sonotrode is pressed onto the workpiece with a predetermined welding force.

In EP 2 105 280 A2, an apparatus has been proposed that has a force sensor for measuring the force applied to the workpiece by the sonotrode.

The sonotrode is usually precisely adapted to the workpiece to be welded. Different sonotrodes are therefore required for different workpieces. Some apparatuses for ultrasonic welding can be converted. With these apparatuses, the sonotrode or the entire welding unit can be replaced. To ensure this interchangeability, the welding unit usually has to be able to travel long distances. Although the convertibility increases the application range of the apparatus, this advantage often comes at the expense of cycle times, so that the cycle times of convertible apparatus are longer than those of apparatus that are designed for only one application (one type of workpiece and one type of sonotrode).

Therefore, apparatus are already known that enable the welding unit to be manually repositioned for each changeover operation.

FIGS. 1a-1c show such an apparatus of the prior art in three positions. The apparatus 10 for ultrasonic welding of a workpiece 100 comprises a machine stand 20, a setting slide 30, a processing slide 40 and a welding unit 50. The apparatus 10 further comprises a control unit (not shown).

The machine stand 20 carries the setting slide 30. The setting slide 30 is movable relative to the machine stand 20 in an infeed direction Z between a rear position and a front position. The rear and front positions represent the extreme positions of the setting slide 30. The rear position is assumed by the setting slide when the setting slide is arranged in its uppermost position in the figures, and the front position is assumed when the setting slide 30 is arranged in its lowermost position in the figures.

The setting slide 30 is connected to the machine stand 20 via a linear guide (not shown), so that it is ensured that the setting slide 30 can only move in the infeed direction Z.

The setting slide 30 is only adjusted during the set-up work, for example to change the welding unit 50 completely or partially or to adapt the welding process to be carried out to a different workpiece with different geometry or different distance to the sonotrode.

The setting slide 30 is adjusted manually during the set-up work. As soon as the setting slide 30 is in its desired position, the setting slide 30 is manually fixed to the machine stand 20. A clamping device (not shown) is generally provided for this purpose. The desired position is generally between the front and rear positions.

This is the basic position for the actual welding process, which is shown in FIG. 1a.

The processing slide 40 is provided on the setting slide 30, which in turn carries the welding unit 50, so that both the welding unit 50 and the processing slide 40 are moved relative to the machine stand 20 during the described setting process by the movement of the setting slide 30 relative to the machine stand 20.

The processing slide 40 has a processing slide drive with which the processing slide can be moved back and forth between a start position and an end position. The start and end positions represent the extreme positions of the processing slide 30. The start position is assumed by the processing slide 40 when the processing slide 40 is arranged in its uppermost position in the figures, and the end position is assumed when the processing slide 40 is arranged in its lowermost position in the figures.

With the help of the processing slide drive, the welding unit 50 is first brought into the position shown in FIG. 1B during the actual machining process, in which the welding unit 50 touches the workpiece 100. As a rule, in this position the speed at which the welding unit 50 is moved in the direction of the workpiece 100 is reduced and the actual welding process is carried out until the end position shown in FIG. 1C is reached. The processing slide 40 is now moved back to the position shown in FIG. 1A, the workpiece 100 is replaced by the next workpiece 100 to be processed and the processing process begins again without the position of the setting slide 30 being changed in the meantime.

Based on the known prior art, it is therefore the object of the present invention to improve the cycle time and the welding accuracy.

### SUMMARY OF THE INVENTION

This object is solved by an apparatus described at the beginning for ultrasonic welding of a workpiece, which has a setting slide drive with which the setting slide can be moved in the infeed direction relative to the machine stand.

The apparatus thus has two slide drives, both of which enable movement of the welding unit in the infeed direction and can be moved automatically and independently of each other.

As a result, the movement of the welding unit can be adapted much better to the respective application. Depending on the welding unit used or the type of workpiece, the slides can then be moved in such a way that the cycle time on the one hand and the welding result on the other are optimized.

The sonotrode and/or the welding unit are preferably detachably connected to the processing slide. In this way, the sonotrode can be replaced.

The welding unit preferably comprises a converter and/or an amplitude transformer.

In some cases, for example with workpieces that require deep immersion, the slides can be moved together by the two slide drives, enabling a high movement speed of the sonotrode in the infeed direction. In this way, the cycle times for this type of component can be kept very short.

The slide drives preferably each comprise a drive unit. The drive units can preferably be activated independently of each other so that the two drives can be controlled or regulated separately.

The slide drives can comprise further components or assemblies, e.g. a gearbox or parts thereof.

The apparatus preferably comprises a control unit. The slide drives, in particular the drive units, are preferably connected to the control unit and can be controlled by the control unit. The control unit thus enables central control of the slide drives. In this way, the movements of the slides can be precisely coordinated with each other.

In advantageous embodiments, an anvil is provided and the welding unit can be moved towards or away from the anvil in the infeed direction with the aid of the setting slide and/or the processing slide. The workpiece is arranged between the anvil and the sonotrode during the welding process. The workpiece can be a continuously conveyed workpiece, for example a material web, or a piece good, for example a plastic housing. The workpiece can also comprise several parts that are welded together. The anvil is preferably adapted to the tool to be welded or can be adapted to different workpieces using adapters. The anvil and/or the adapters can be configured as a workpiece receptacle into which the workpiece can be placed.

The machine stand and/or the setting slide and/or the processing slide preferably has a linear guide that only allows relative movement between the setting slide and the machine stand or between the processing slide and the setting slide in the infeed direction. This ensures that the slides only move in the infeed direction. A common linear guide can be provided for both slides, which simplifies the superstructure of the apparatus. Alternatively, each carriage can have its own linear guide. In this case, each linear guide can be precisely adapted to the respective carriage, which improves the precision of the movement in particular.

In advantageous embodiments, the setting slide drive and/or the processing slide drive comprises an electric and/or pneumatic and/or hydraulic drive unit. It is of particular advantage if the drive units of the two slide drives are of the same type, e.g. both are electric drive units. In this way, only one type of drive source, for example a power connection or a compressor, needs to be provided. In some embodiments, however, the drive units are of different types.

This has the advantage that the drive units can be adapted precisely to the slides and their movement. If, for example, the setting slide is only to perform a rough but fast positioning and the processing slide is to perform a very precise movement, i.e. with a low tolerance, a drive unit of one type, e.g. an electric drive unit, can be used for the setting slide and a drive unit of another type, e.g. a pneumatic drive unit, can be used for the processing slide.

In advantageous embodiments, a first displacement sensor is provided for detecting a relative position between the machine stand and the processing slide and/or a second displacement sensor is provided for detecting a relative position between the welding unit and the anvil or between the welding unit and a workpiece positioned between the welding unit and the anvil. In this way, the movements of the slides and/or the welding unit can be precisely detected and compared with set values, for example, in order to control the movement. The displacement sensors are therefore preferably connected to the control unit and configured to transmit measured values to the control unit. The control unit is preferably configured to receive the measured values from the displacement sensors and compare them with setpoint values and also preferably to control the drive unit(s) depending on the measured values and/or the comparison between measured values and setpoint values.

For the welding process, it is necessary for the sonotrode and the workpiece to be in contact. As a rule, the sonotrode continues to be pressed against the workpiece even after contact has been made between the sonotrode and the workpiece by moving the sonotrode in the infeed direction. The sonotrode can be activated, i.e. set in vibration, both before and after contact.

In advantageous embodiments, a force sensor is provided to determine the welding force with which the sonotrode is pressed against a workpiece positioned between the sonotrode and anvil. The force sensor is preferably connected to the control unit and configured to transmit measured values to the control unit. The control unit is preferably configured to receive the measured values from the force sensor and compare them with set values and also preferably to control the drive unit(s) depending on the measured values and/or the comparison between measured values and set values. The detection of the welding force can be used in particular to start and/or end the welding process. If a certain setpoint value is reached, the control unit switches off the drive unit(s) or controls them in such a way that the sonotrode moves away from the workpiece. This releases the workpiece and allows it to be removed from the anvil.

As already mentioned, a welding force is applied during the welding process, which also stresses the drive unit(s). This can lead to faster/greater wear of the drive unit(s). In advantageous embodiments, it is provided that the setting and/or processing slide has a clamping device which can be switched or moved back and forth between a clamped state and an un-clamped state, whereby in the clamped state the relative movement of the setting slide with respect to the machine stand or the relative movement of the processing slide with respect to the setting slide is prevented and in the unclamped state the relative movement of the setting slide with respect to the machine stand or the relative movement of the processing slide with respect to the setting slide is not prevented. The clamping device relieves the respective drive unit so that it can manage with weaker drive axes. It is therefore particularly preferable that the setting slide drive is relieved by a clamping device and only the processing slide causes the movement of the welding unit during the welding process. The welding force is then introduced into the machine stand by means of the clamping device, bypassing the drive unit of the setting slide drive. In a preferred embodiment, the clamping device can be activated and deactivated with the help of the control device. Manual intervention to activate the control device is therefore not necessary.

Several movement profiles for the setting slide drive and/or the processing slide drive are preferably stored in the control unit connected to the setting slide drive and/or the processing slide drive. A movement profile preferably comprises set values for the displacement sensors and/or the force sensor and/or control values for controlling the slide drives, whereby the values can be stored in combination with time specifications. In particular, the movement profiles are adapted to different workpieces and/or sonotrodes. In these embodiments, the sonotrode is preferably interchangeable. For example, one movement profile may provide for the setting slide drive to be switched off when the first displacement sensor transmits a predetermined measured value to the control unit. In another movement profile, for example, it may be specified that the setting slide drive is first activated for a predetermined period of time. Each movement profile preferably comprises several such steps. The movement profiles each represent a complete work process including movement of the sonotrode towards the workpiece, welding process and movement of the sonotrode away from the workpiece.

The control unit is preferably configured in such a way that it can recognize the type of sonotrode. The movement profile can then be selected depending on the detected sonotrode. The sonotrode or welding unit can be detected using RFID (radio-frequency identification), for example. The control unit is then preferably connected to an RFID reader and each sonotrode or welding unit or its support or each workpiece receptacle or workpiece has an RFID transponder.

Alternatively, the type of sonotrode and/or the type of workpiece and/or the type of workpiece receptacle can also be transmitted to the control unit by a user. Here too, the control unit is then configured to select the movement profile depending on the detected sonotrode.

The welding force has an influence on the result of the welding process. Both too low and too high a welding force can lead to a faulty weld. It is therefore desirable to set the welding force optimally. In advantageous embodiments, it is therefore provided that a spring device is provided between the machine stand and the welding unit, which is arranged and configured in such a way that the welding unit can be moved relative to the machine stand in the infeed direction between an infeed position and a welding position. The spring device can be pre-loaded. Preferably, the spring device is configured in such a way that it presses the welding unit in the direction of the welding position, preferably exerting a force on the welding unit in the direction of the welding position. The welding force can be preset by the design of the spring device, in particular with regard to its spring characteristic curve, and the extent of the preload, in particular the spring travel. In particular, the welding force is understood to be the force with which the sonotrode is pressed against the workpiece. The spring device can also be realized by a gas pressure spring. In a preferred embodiment, a control and/or regulating device is provided with which the pressure of the gas pressure spring can be adjusted and/or regulated.

The apparatus is preferably a manually operable device (manual workstation). For this purpose, the apparatus preferably has a human-machine interface (HMI) with at least one, preferably two, buttons for starting a welding process. The HMI can also be a touch display. The HMI is preferably configured so that a user can use the HMI to transmit the type of sonotrode and/or the type of workpiece to the control unit. The HMI is preferably connected to the control unit.

The apparatus preferably has a workpiece receptacle.

The infeed direction preferably runs in the direction of gravity.

The invention also relates to a method for operating an apparatus for ultrasonic welding of a workpiece according to the above description, comprising the steps of:
A) Positioning the workpiece at a position which is spaced from the sonotrode in the infeed direction,
B) moving the setting slide in the direction of the front position to an initial position,
C) moving the processing slide in the direction of the end position up to a predetermined final welding position.

Steps A, B, C are preferably carried out in this order. Alternatively, the processing slide can be moved first and then the setting slide.

Preferably, the sonotrode is induced with an ultrasonic vibration during step C). The sonotrode can also be induced with an ultrasonic vibration before the start of step C) and/or after the end of step C).

Preferably, the setting slide and/or the processing slide is moved in a subsequent step D) in such a way that the sonotrode is removed from the workpiece. The workpiece can then be removed. Preferably, both slides are moved so that the workpiece is quickly released.

In step B), the initial position is preferably selected so that in the initial position the sonotrode is just in front of the workpiece or touches the workpiece. In this way, the processing slide only performs the actual welding movement. In this case, the processing slide drive can be a very precise drive compared to the setting slide drive, which enables very precise welding.

In a preferred embodiment, the initial position is selected in step B) so that the setting slide is moved a little further towards the front position after contact with the workpiece. If the processing slide is spring-mounted, it will move towards the starting position due to the force exerted by the workpiece on the sonotrode. As soon as a predetermined welding start position is reached, which is determined, for example, by the welding force exerted by the spring, the actual welding process can be started immediately in the subsequent step C). It is therefore particularly preferred that the welding force is recorded in step B) and the initial position is determined as the position at which a predetermined welding force is reached.

In a further preferred embodiment, an apparatus according to claim 9 is used and during or before step B) the processing slide is moved to its end position and in step B) the setting slide is moved in the direction of the front position until the processing slide comes into contact with the workpiece and is pressed by the workpiece in the direction of the rear position against a spring force of the spring device and the spring force reaches a predetermined welding force. The initial position is thus determined by the predetermined welding force.

### BRIEF DESCRIPTION OF THE DRAWINGS

The invention is illustrated and explained below with reference to the drawings. Shown are

FIGS. 1a to 1c an apparatus of the prior art in three positions;

FIGS. 2a to 2d an apparatus according to the invention in four positions according to a first embodiment of the method according to the invention;

FIGS. 3a to 3d the apparatus according to the invention in four positions according to a second embodiment of the method according to the invention; and

FIGS. 4a to 4e the apparatus according to the invention in five positions according to a third embodiment of the method according to the invention.

### DETAILED DESCRIPTION OF THE INVENTION

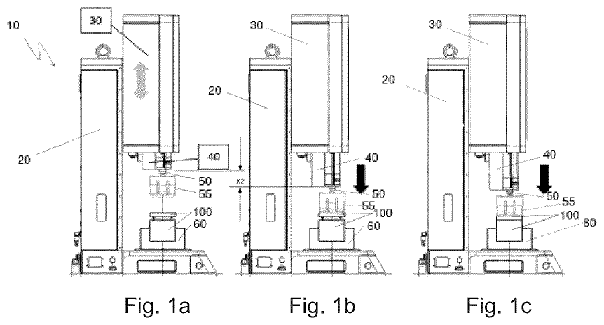

The apparatus shown in FIGS. 1a-1c and the welding method shown therein are already known from the prior art and have already been explained above.

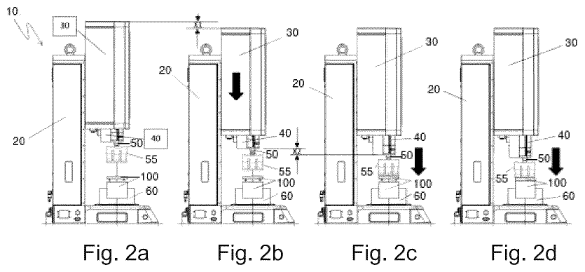

FIGS. 2a-2d show an embodiment of the apparatus according to the invention, using the same reference signs as in FIGS. 1a-1c.

The essential difference is that, according to the invention, the setting slide 30 has a setting slide drive (not shown), with which the setting slide 30 can be moved relative to the machine stand 20 during machining. The apparatus 10 according to the invention can thus be used, for example, to realize the embodiment of the method according to the invention shown in FIGS. 2a-2d.

FIG. 2a shows the basic position at which the machining process of the workpiece 100 starts. In the first step, the setting slide 30 is now moved using a control unit (not shown) by a distance X1 in the direction of its front position, i.e. downwards in the figures, so that it reaches the working position shown in FIG. 2b.

In this position, a clamping device is activated with the help of the control unit, which prevents further relative movement between the machine stand 20 and the setting slide 30 and thus relieves the load on the setting slide drive.

In the next step, the processing slide 40 is now used to move the welding unit or the sonotrode by the distance X2 in the direction of the end position until the position shown in FIG. 2c, in which the sonotrode 55 contacts the workpiece 100, is reached.

During the movement around the distance X2, the welding unit can already be subjected to an ultrasonic vibration, so that the sonotrode 55 is already vibrating. However, it is also possible to activate the ultrasonic vibration only when the position shown in FIG. 2c has been reached.

Now the processing slide 40 is moved further towards its end position in order to process the workpiece 100. As soon as machining is complete, both the processing slide 40 and the setting slide 30 are moved back to their starting position shown in FIG. 2A. This can be done either in reverse order, i.e. first the processing slide 40 is moved back and then the setting slide 30 is moved back, or simultaneously. The simultaneous movement of both the processing slide 40 and the setting slide 30 can reduce the cycle time.

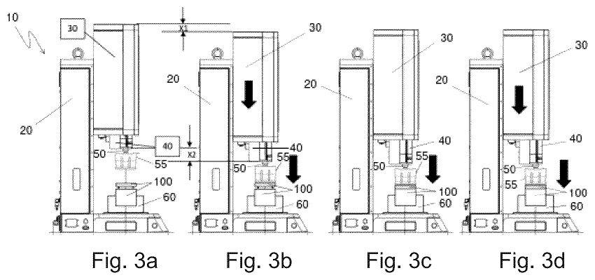

FIGS. 3a to 3d show a second embodiment of a method according to the invention using the apparatus according to the invention. FIG. 3a shows the basic position, which is identical to the basic position shown in FIG. 2a. In the first step, the setting slide 30 is now moved by the distance X1 and at the same time the processing slide is moved by the distance X2 until the sonotrode 55 touches the workpiece 100 and the position shown in FIG. 3b is reached.

The method shown in FIGS. 3a-3d thus differs from the methods shown in FIGS. 2a to 2d in that the movement of both the setting slide 30 and the processing slide 40 in the direction of the workpiece does not take place successively, but simultaneously, whereby the cycle time can be shortened.

In this embodiment, there are two options for applying the ultrasonic vibrations to the workpiece. In the first variant, the setting slide 30 is stopped in the position shown in FIG. 3B and, if necessary, automatically fixed with the locking device. The actual processing is then carried out exclusively by moving the processing slide in the direction of the end position until the position shown in FIG. 3c is reached.

Alternatively, in the second variant, the actual processing, i.e. the movement of the sonotrode towards the workpiece while it is exposed to ultrasound and touches the workpiece, can also be caused both by the movement of the setting slide 30 and by the movement of the processing slide 40. This possibility is shown schematically in FIG. 3d.

After completion of the welding process, both the infeed slide 30 and the processing slide 40 are then returned to the basic position shown in FIG. 3a.

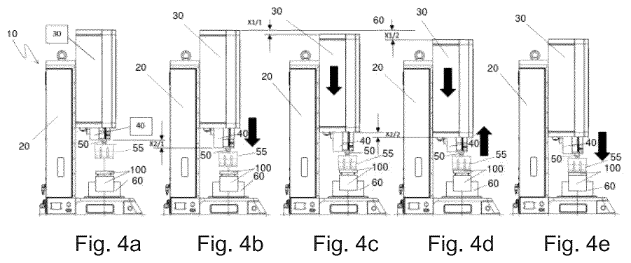

FIGS. 4a-4e show a third embodiment of the method according to the invention.

In FIG. 4a, the basic position is again shown, which is identical to the basic position shown in FIGS. 2a and 3a.

In the first step, the sonotrode 55 is now moved in the direction of the workpiece 100 with the aid of the processing slide 40. It is particularly preferred if the processing slide moves to its end position, for example against a provided end stop. This position is shown in FIG. 4b.

In the next step, the setting slide 30 is now used to move the welding unit 50 together with the processing slide in the direction of the front position of the setting slide 30 until the sonotrode touches the workpiece. This situation is shown in FIG. 4c.

However, the movement of the setting slide 30 does not end in this position. Instead, the setting slide 30 is moved further in the direction of the workpiece 100. As the sonotrode is already in contact with the workpiece, the workpiece 100 exerts a force on the sonotrode 55. In the embodiment shown, the processing slide 40 is spring-mounted. This can be done using a gas pressure spring, for example. The force exerted by the workpiece 100 on the sonotrode 55 and thus on the processing slide 40 pushes the processing slide 40 in the direction of its starting position. In other words, although the setting slide 30 moves a certain distance in the direction of the workpiece 100, the welding unit 50 will only move a slightly shorter distance in the direction of the workpiece 100. The spring-loaded mounting allows the desired welding pressure to be applied to the workpiece.

In this position, i.e. when the desired welding force is reached, the movement of the setting slide 30 is stopped and, if necessary, it is fixed to the machine stand with the aid of the clamping device and further processing, i.e. the movement of the processing slide 40 in the direction of the workpiece, is carried out via the drive of the processing slide 40.

The apparatus and the method described make it possible to quickly and reliably convert the apparatus and to achieve deep-seated welds in a short cycle time.

### LIST OF REFERENCE SYMBOLS

10 Apparatus
20 Machine stand
30 Setting slide
40 Processing slide
50 Welding unit
55 Sonotrode
60 Anvil/workpiece receptacle
100 Workpiece
Z Infeed direction

What is claimed is:

1. An apparatus for ultrasonic welding of a workpiece (49) comprising:
a machine stand,
a welding unit having a sonotrode, and
a setting slide which is connected to the machine stand, carries the welding unit and can be moved in an infeed direction (Z) relative to the machine stand between a rear position and a front position,
wherein a processing slide connected to the welding unit and the setting slide is provided, which can be moved together with the welding unit in the infeed direction (Z) relative to the setting slide between a start position and an end position,
wherein a processing slide drive is provided, with which the processing slide can be moved in the infeed direction (Z) relative to the setting slide, and
wherein a setting slide drive is provided with which the setting slide can be moved in the infeed direction (Z) relative to the machine stand.

2. The apparatus according to claim 1, wherein an anvil is provided and the welding unit can be moved towards or away from the anvil in the infeed direction (Z) with the aid of the setting slide and/or the processing slide.

3. The apparatus according to claim 1, wherein the machine stand and/or the setting slide and/or the processing slide have a linear guide which allows a relative movement between the setting slide and the machine stand or between the processing slide and the setting slide only in the infeed direction (Z).

4. The apparatus according to claim 1, wherein the setting slide drive and/or the processing slide drive comprises an electric and/or pneumatic and/or hydraulic drive unit.

5. The apparatus according to claim 1, wherein a first displacement sensor is provided for detecting a relative position between the machine stand and the processing slide and/or a second displacement sensor is provided for detecting a relative position between the welding unit and the anvil or between the welding unit and a workpiece positioned between the welding unit and the anvil.

6. The apparatus according to claim 1, wherein a force sensor is provided for determining a welding force with which the sonotrode is pressed against a workpiece positioned between the sonotrode and the anvil.

7. The apparatus according to claim 1, wherein the setting slide and/or the processing slide has a clamping device which can be switched or moved back and forth between a clamped state and an unclamped state, wherein in the clamped state the relative movement of the setting slide with respect to the machine stand or the relative movement of the processing slide with respect to the setting slide is prevented and in the unclamped state the relative movement of the setting slide with respect to the machine stand or the relative movement of the processing slide with respect to the setting slide is not prevented.

8. The apparatus according to claim 1, wherein the apparatus comprises a control unit which is connected to the setting slide drive and/or the processing slide drive and in which a plurality of movement profiles for the setting slide and/or the processing slide are stored.

9. The apparatus according to claim 1, wherein a spring device is provided between the machine stand and the welding unit, which is arranged and configured in such a way that the welding unit can be moved relative to the machine stand in the infeed direction between an infeed position and a welding position.

10. A method for operating the apparatus according to claim 1 for ultrasonic welding of a workpiece, comprising the steps of:
A) positioning the workpiece at a position which is spaced from the sonotrode in the infeed direction (Z),
B) moving the setting slide in the direction of the front position up to an initial position,
C) moving the processing slide in the direction of the end position up to a predetermined welding end position.

11. The method according to claim 10, characterized-in-that wherein during step C) the sonotrode is induced with an ultrasonic vibration.

12. The method according to claim 10, wherein in step B) the initial position is selected such that in the initial position the sonotrode touches the workpiece.

13. The method according to claim 10, wherein, in step B), the processing slide is additionally moved in the direction of the end position up to a predetermined welding start position.

14. The method according to claim 10, wherein in step B) the welding force is detected and the initial position is determined as the position at which a predetermined welding force is reached.

15. The method according to claim 10, wherein a spring device is provided between the machine stand and the welding unit, which is arranged and configured in such a way that the welding unit can be moved relative to the machine stand in the infeed direction (Z) between an infeed position and a welding position, wherein during or before step B) the processing slide is moved to its end position and that in step B) the setting slide is moved in the direction of the front position until the processing slide comes into contact with the workpiece and is pressed by the workpiece in the direction of the rear position against a spring force of the spring device and the spring force reaches a predetermined welding force.

16. The apparatus according to claim 2, wherein the machine stand and/or the setting slide and/or the processing slide have a linear guide which allows a relative movement between the setting slide and the machine stand or between the processing slide and the setting slide only in the infeed direction (Z), and wherein the setting slide drive and/or the processing slide drive comprises an electric and/or pneumatic and/or hydraulic drive unit.

17. The apparatus according to claim 16, wherein a first displacement sensor is provided for detecting a relative position between the machine stand and the processing slide and/or a second displacement sensor is provided for detecting a relative position between the welding unit and the anvil or between the welding unit and a workpiece positioned between the welding unit and the anvil, and wherein a force sensor is provided for determining a welding force with which the sonotrode is pressed against a workpiece positioned between the sonotrode and the anvil.

18. The apparatus according to claim 17, wherein the setting slide and/or the processing slide has a clamping device which can be switched or moved back and forth between a clamped state and an unclamped state, wherein in the clamped state the relative movement of the setting slide with respect to the machine stand or the relative movement of the processing slide with respect to the setting slide is prevented and in the unclamped state the relative movement of the setting slide with respect to the machine stand or the relative movement of the processing slide with respect to the setting slide is not prevented, wherein the apparatus comprises a control unit which is connected to the setting slide drive and/or the processing slide drive and in which a plurality of movement profiles for the setting slide and/or the processing slide are stored, and wherein a spring device is provided between the machine stand and the welding unit, which is arranged and configured in such a way that the welding unit can be moved relative to the machine stand in the infeed direction (Z) between an infeed position and a welding position.

19. The method according to claim 11, wherein in step B) the initial position is selected such that in the initial position the sonotrode touches the workpiece, and wherein, in step B), the processing slide is additionally moved in the direction of the end position up to a predetermined welding start position.

20. The method according to claim 19, wherein in step B) the welding force is detected and the initial position is determined as the position at which a predetermined welding force is reached, and wherein a spring device is provided between the machine stand and the welding unit, which is arranged and configured in such a way that the welding unit can be moved relative to the machine stand in the infeed direction (Z) between an infeed position and a welding position, wherein during or before step B) the processing slide is moved to its end position and that in step B) the setting slide is moved in the direction of the front position until the processing slide comes into contact with the workpiece and is pressed by the workpiece in the direction of the rear position against a spring force of the spring device and the spring force reaches a predetermined welding force.
